(19) United States
(12) Patent Application Publication
(10) Pub. No.: US 2003/0071439 A1
(43) Pub. Date: Apr. 17, 2003

(54) Bike stand

(76) Inventor: Peter Kirk Haugen, Portland, OR (US)

Correspondence Address: KOLISCH HARTWELL, P.C., 520 S.W. YAMHILL STREET, SUITE 200, PORTLAND, OR, 97204, US

(21) Appl. No.: 10/227,602

(22) Filed: Aug. 23, 2002

Related U.S. Application Data
(60) Provisional application No. 60/314,624, filed on Aug. 23, 2001.

(51) Int. Cl. B62H 1/00

(52) U.S. Cl. 280/293; 280/295

(57) ABSTRACT

A portable bike stand that supports a bicycle in a vertical position and a method of using the bike stand to park the bicycle. The bike stand includes support elements that are coupled to the frame of the bicycle. The support elements provide support surfaces that cooperate with the bicycle to support the bicycle in the vertical position. In some embodiments, the bike stand also provides a storage compartment for carrying cargo.

### FIELD OF THE INVENTION

The present invention relates to a bike stand. More specifically, the invention relates to a bike stand carried on a bicycle and configured to support the bicycle vertically.

### BACKGROUND

Bike stands allow bicycles to be stored in various positions. Some bike stands are mounted on a bicycle and carried by the bicycle, providing a support system whenever a bicycle rider parks the bicycle. An example of such a mobile stand is a kick stand, which is commonly mounted on a bicycle and “kicked” by a rider into a deployed position from a storage position. In the deployed position the rider can use the kick stand to hold a bicycle in a horizontal position with front and rear wheels both contacting the ground.

However, the kick stand has a number of disadvantages. For example, the kick stand does not provide a space-efficient storage position for the bicycle. Since the bicycle is parked horizontally, storage space for the bicycle's entire length is required. In addition, the kick stand is not a very stable storage mechanism. The kick stand produces a triangular contact configuration, in conjunction with the wheels, that places the bicycle's center of mass a relatively short horizontal distance from a side of the contact configuration. This is a relatively unstable configuration; any moderate mechanical force directed at the bicycle from the kick-stand side has a tendency to knock the bicycle from its standing position.

Bicycle storage mechanisms that may be more stable and space efficient than the kick stand have been developed, but are usually not carried on the bicycle. These storage mechanisms may be capable of stably positioning and holding the bicycle in a vertical orientation, thus reducing storage space occupied by the bicycle. For example, a mounted hook is used commonly to suspend a front or rear wheel from a ceiling of a room, such as a garage. However, such a bike storage mechanism cannot be carried easily by the bicycle and thus is impractical for temporary storage during a bicycle trip. Therefore, a bike stand is required that is mounted on the bicycle and provides a stable, mobile, and space-efficient mechanism for supporting and parking a bicycle. Furthermore, a dual function bike stand is required that also provides the ability to carry cargo.

### SUMMARY OF THE INVENTION

The present invention provides a portable bike stand that supports a bicycle in a vertical position. A method of using the bike stand to park the bicycle is also provided. The bike stand includes support elements that are coupled to the frame of the bicycle. The support elements provide support surfaces that cooperate with the bicycle to support the bicycle in the vertical position. In some embodiments, the bike stand also provides a storage compartment for carrying cargo.

### BRIEF DESCRIPTION OF THE DRAWINGS

FIG. 1 is a side elevation view of an embodiment of a bike stand mounted in a deployed position on a carrier rack of a bicycle, in accordance with aspects of the invention.

FIG. 2 is a top plan view of the bike stand and bicycle of FIG. 1.

FIG. 3 is a rear elevation view of the bike stand and bicycle of FIG. 1.

FIG. 4 is a fragmentary side elevation view of the bike stand and bicycle of FIG. 1, in which the bike stand is being used to support the bicycle in a vertical position, in accordance with aspects of the invention.

FIG. 5 is a fragmentary side elevation view of an embodiment of a collapsible bike stand mounted on a frame of a bicycle, showing collapsed (stowed) and partially deployed positions, in accordance with aspects of the invention.

FIG. 6 is a fragmentary side elevation view of the collapsible bike stand of FIG. 5 in a deployed position on the bicycle, in accordance with aspects of the invention.

FIG. 7 is a fragmentary top plan view of the bike stand of FIG. 5 in a stowed, collapsed position on the bicycle.

FIG. 8 is a fragmentary top plan view of the deployed bike stand and the bicycle of FIG. 6.

FIG. 9 is a fragmentary rear elevation view of the collapsed bike stand and the bicycle of FIG. 5.

FIG. 10 is a fragmentary rear elevation view of the deployed bike stand and the bicycle of FIG. 6.

FIG. 11 is a side elevation view of an embodiment of a bike stand that includes a cargo container and is attached to a bicycle in a horizontal riding position, in accordance with aspects of the invention.

FIG. 12 is a top plan view of the bike stand and the bicycle of FIG. 11.

FIG. 13 is a fragmentary side elevation view of the bike stand and the bicycle of FIG. 11 with the bike stand supporting the bicycle in a vertical position, in accordance with aspects of the invention.

FIG. 14 is fragmentary side elevation view of the bike stand and the bicycle of FIG. 13, showing the cargo container in an open position while the bike stand continues to support the bicycle vertically, in accordance with aspects of the invention.

### DETAILED DESCRIPTION AND BEST MODE FOR CARRYING OUT THE INVENTION

The present invention provides a portable bike stand for attachment to a bicycle. The bike stand provides first and second supports that cooperate with a rear wheel of the bicycle, or a rear wheel-associated support. The supports alone or in conjunction with the rear wheel allow the bicycle to be stably re-positioned from a horizontal riding position to a vertical storage position in which the front wheel of the bicycle is positioned above the rear wheel. In the vertical storage position, the first and second supports, and the rear wheel or third support, support (or stably balance) the bicycle vertically by defining a support triangle, above which the bicycle's center of mass is positioned.

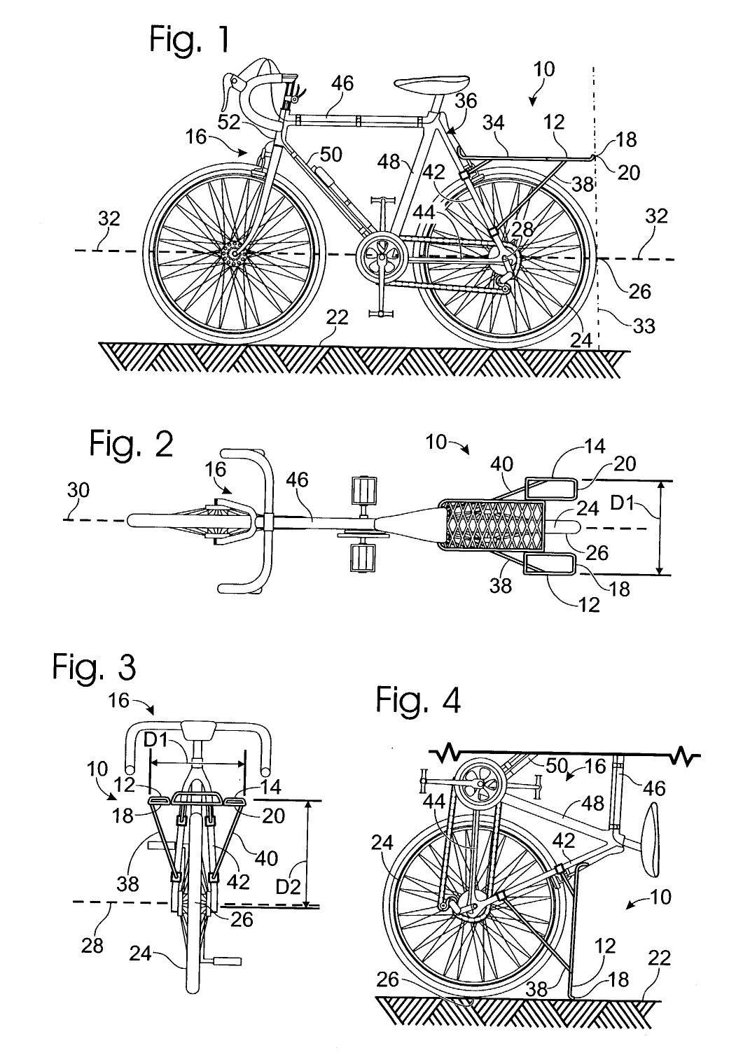

FIGS. 1-4 show an example of a bike stand 10 constructed in accordance with the present invention. Bike stand 10 generally includes supports 12 and 14 attached to a bicycle 16. Bicycle 16 is shown in a horizontal riding position in FIG. 1 and in a vertical position in FIG. 4, with bike stand 10 supporting the bicycle so that it is balanced and resists tipping over. Supports 12 and 14 include support surfaces 18 and 20 that determine two spaced sites of contact with a horizontal surface 22 when the bike stand is supporting the bicycle. Surfaces 18 and 20 may cooperate with a rear wheel 24 of bicycle 16. In the example of bike stand 10, a current rear surface of rear wheel 24, generally a rearmost perimeter region of the tire of the rear wheel, provides wheel support surface 26.

For the purposes of defining positions relative to bicycle 16, the bicycle is considered to have three orthogonal axes that are defined by the horizontal riding position of the bicycle. These axes extend between the front and rear of the bicycle, between the top and bottom of the bicycle, and between the sides of the bicycle. The wheel support surface, along with surfaces 18 and 20, may form a support triangle, or triangular-shaped contact configuration, readily seen in FIG. 3.

FIGS. 2 and 3 show how surfaces 18 and 20 may be positioned relative to the bicycle. Surfaces 18 and 20 are positioned in a rear portion of the bicycle, substantially above center or rotational axis 28 of rear wheel 24, on opposite sides of the bicycle's rear wheel or central plane 30, preferably in a symmetrical relationship with the bicycle. Surfaces 18 and 20 are spaced by a distance D1 and preferably define a line that extends substantially orthogonal to central plane 30 of the bicycle. The line is spaced from wheel support surface 26 or a wheel-proximate support surface (see below), by a distance D2. D1 and D2 are measured from the perimeters of the contact surfaces (see FIGS. 2 and 3). Together, bike-stand support surfaces 18, 20 and wheel support surface 26 (or a wheel-proximate support surface) define a support triangle that is generally orthogonal to long axis 32. Long axis 32 is defined as parallel to the bottom of the front and rear wheel and extends through rotational axis 28 of rear wheel 24.

In all embodiments, for the bike stand to balance the bicycle, a vertical projection of the bicycle's center of mass onto a horizontal support surface falls within the support triangle when the three support surfaces (or three of four or more support surfaces) simultaneously contact the ground or other horizontal surface. Otherwise, the bicycle is not balanced and will fall over. The center of mass may be for the bicycle alone or, with a heavier bike stand having a non-negligible weight, for the bicycle and the bike stand together. Standard bicycles have a center of mass that is disposed about four to eight inches above the crank (pedal axis). This average center-of-mass position may be used as a general guide for positioning the support elements and their support surfaces.

The vertical projection may be generally centered within the triangle to give the supported bike stability, for example, to resist forces that may topple the bicycle, such as wind, accidental contact, or the like. Here, generally centered means that the distance of the vertical projection from each side of the support triangle varies by less than about three-fold or less than about two-fold.

Values of D1 and D2 may be selected based on an average bicycle configuration, as described above, a specific bicycle's total mass, and/or the specific bicycle's center-of-mass position. In preferred embodiments, distance D1 is at least about one-half of D2. For an average adult bicycle, distance D1 may be at least about six inches or at least about ten inches. However, a heavier bicycle may be supported more stably with the bike stand by increasing values of D1 and/or D2, whereas a smaller, lighter bicycle, such as a children's bicycle may be supported sufficiently with decreased values of D1 and/or D2.

Support surfaces of the bike stand are positioned to support the bicycle in an at least substantially vertical position. A bicycle supported in an at least substantially vertical position has long axis 32 disposed at within about twenty degrees, about ten degrees, or about five degrees of exactly vertical, that is, normal to horizontal surface 22. The deviation from exactly vertical may be determined by the position of bike-stand support surfaces 18, 20, along a front to rear axis, relative to wheel (or wheel-proximate) support surface 26. Support surfaces 18, 20 may be about even with wheel support surface 26, or may be disposed somewhat frontward of the wheel support surface, as shown in FIG. 1 by dashed line 33. Frontward placement produces a support triangle that slants forward when the bicycle is horizontal, by less than about 20, 10, or 5 degrees. A slanted support triangle may position the center of mass of the bicycle more centrally above the support triangle when the bicycle is supported vertically. The slanted support triangle may be beneficial because the center of mass of an average bicycle is an average of about four to eight inches above wheel support surface 26 on the horizontal bicycle. Accordingly, to stand the bicycle in a substantially vertical position, the bicycle may be pivoted upward (clockwise in FIG. 1) by more than 90 degrees. By contrast, a vertical or unslanted support triangle support is implemented for bike support by pivotal movement of about 90 degrees. In either case, the support triangle is at least substantially vertical when bicycle 16 is in a horizontal riding configuration.

In some embodiments, wheel support surface 26 may be replaced with a wheel-proximate support surface. Such a wheel-proximate support surface may be provided by a fender or a frame extension, among others, that is disposed rearward of wheel support surface 26, at approximately the height of wheel support surface 26.

In the example of FIGS. 1-4, bike stand 10 is attached to both a bicycle rack carrier 34 and to frame 36 of bicycle 16. Attachment to the frame is with braces 38 and 40. Braces 38 and 40 are shown as mounted on seat stays 42. Alternatively, braces 38 and 40 may be mounted on chain stays 44, top tube 46, seat tube 48, down tube 50, head tube 52, and/or any other suitable portion of frame 36. Alternatively, or in addition, supports 12 and 14 may be attached only to rack carrier 34 or frame 36, or may be formed integrally with one or the other. In this example, rack 34 is a generally horizontal structure extending above rear wheel 24 and includes sites for attaching cargo directly or for attachment cargo-carriers such as panniers, baskets, etc. However, any cargo-carrying device that provides appropriately-positioned supports 12 and 14 may be suitable. Such cargo carriers should be rigid enough to hold the support surfaces of the supports in a substantially fixed position relative to the bicycle. Cargo carriers generally include any rigid rack, basket, box, or other carrier configured to carry cargo.

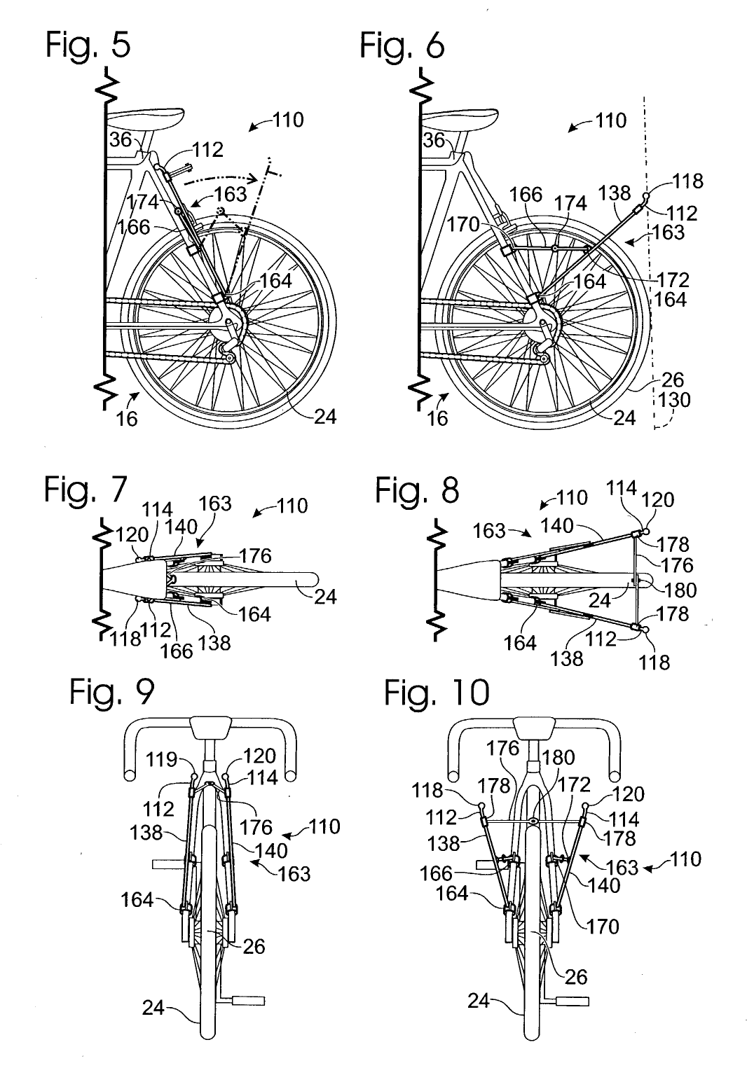

FIGS. 5-10 depict another embodiment of a bike stand 110 constructed according to the present invention. Bike stand 110 may be used without rack 34 or other cargo carrier. This bike stand allows supports 112 and 114 to be moved between a stowed position, shown in FIGS. 5, 7, and 9, and a deployed or working position, shown in FIGS. 6, 8, and 10. In this example of a collapsible bike stand, a collapsible frame 163 positions supports 112 and 114. Frame 163 includes braces 138 and 140 that hold supports 112 and 114 at a variable distance from bicycle frame 36 along a front-to-rear axis of the bicycle. Braces 138 and 140 each include a pivot point 164 that allows each brace to pivot between a stowed position, which is adjacent to and generally aligned with frame 36, and a deployed position that extends away from bicycle frame 36. Support braces 166 may be used to help define the deployed position of braces 138 and 140 and generally include pivotable attachments 170 and 172 at each end and a locking pivot 174 at an intermediate position (see FIG. 6). Spacing between contact surfaces 118 and 120 in the deployed position may be additionally determined by cross brace 176, which includes pivotable attachments 178 and locking pivot 180 positioned intermediate to attachments 178 (see FIG. 8). As readily seen by comparing FIGS. 7 and 9 with FIGS. 8 and 10, cross brace 176 acts to maintain a spaced position of supports 112 and 114 relative to rear wheel 24 and wheel support surface 26. It should be noted that frame 163 is one of many possible examples for a collapsible frame. Any frame may be used that is capable of positioning support members between a stowed position and a stably deployed position that allows bicycle 16 to stand at least substantially vertically.

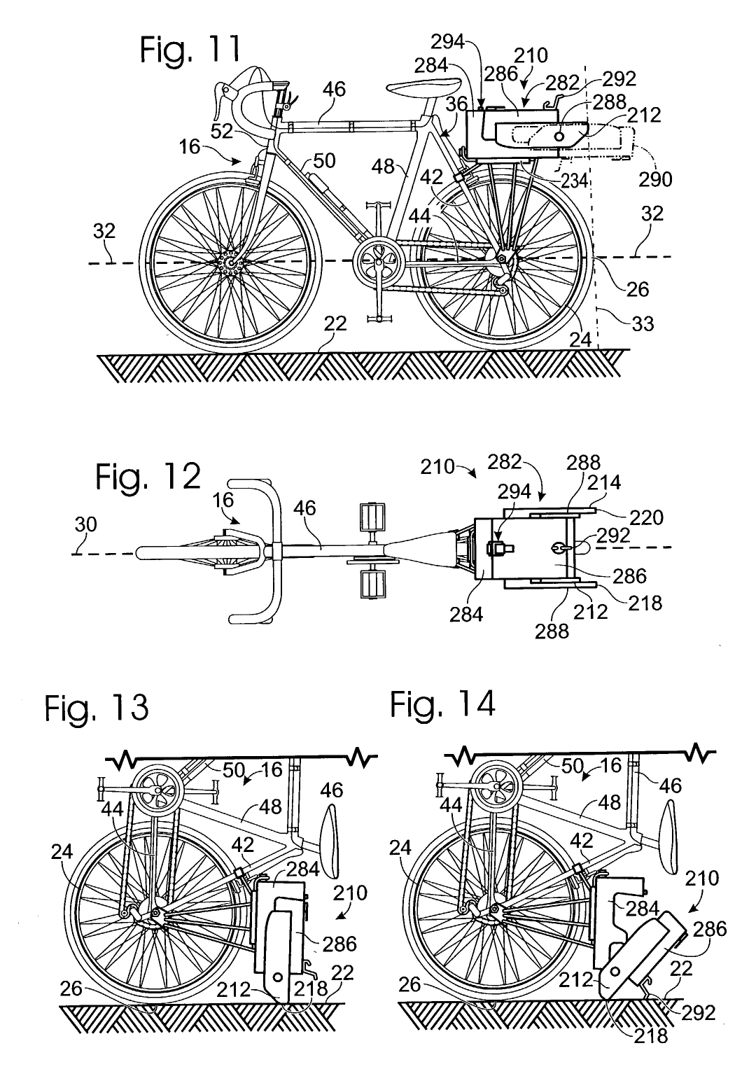

FIGS. 11-14 show another embodiment of a bike stand 210. In this embodiment, stand 210 includes a cargo carrier 282. The cargo carrier may be mounted on a carrier rack 234, as shown, and/or may be attached to the bicycle frame. Cargo carrier 282 generally includes a base portion 284, which supports and contains cargo, and a door or cover 286, which is operable to fully close the cargo carrier and prevent removal of cargo. Door 286 may be hinged to base portion 284 using any suitable hinging mechanism, such as hinge assemblies 288, or may be fit onto, but be fully separable from, the base portion. Here, door 286 is pivotal by about 180 degrees to a fully opened position, shown at 290 in dotted outline in FIG. 11. In this fully opened position, the door contacts the base portion and is prevented from further pivotal movement. In the embodiment shown, opened door 286 increases the area that is available for supporting cargo, and thus may be used in this open position to assist in carrying larger loads. Hooks, brackets, or other attachment structures, such as hook 292, may be positioned externally or internally to facilitate securing cargo when door 286 is open and/or closed.

In some embodiments, door 286 may include a latching mechanism or a locking mechanism 294. Mechanism 294 may allow the door to be secured in the closed position and/or locked to prevent theft of the cargo. As another security feature, base portion 284 may be attached to rack 234 or the bicycle frame using fasteners that are accessible only from the interior of the cargo carrier, to prevent theft of the cargo carrier.

Bike stand 210 includes supports 212, 214 that provide support surfaces 218, 220, respectively, for at least substantially vertical bike support. Support surfaces 218, 220 are positioned and operate as described above for support surfaces 18, 20. Supports 212, 214 may be distinct projections that extend generally rearward from a body of cargo carrier 282. As shown in FIGS. 11, 13, and 14, the supports may be connected to door 286 and pivot relative to base portion 284 when door 286 is opened. For example, supports 212, 214 may be structured to allow door 286 to be opened partially while the bicycle is supported (compare FIGS. 13 and 14). Door 286 may pivot until stopped by contact of the door with the ground, for example, through contact of hook 292 with horizontal surface 22. In alternative embodiments, supports 212, 214 may be attached to cargo portion 284 instead or door 286. Alternatively, or in addition, supports 212, 214 may not project from the body of cargo carrier 282, but may be nonprojecting surface regions of the body, that is, of base portion 284 and/or door 286.

Each of the bike stands illustrated by the foregoing examples positions a bicycle at least substantially vertically, with the front wheel above the rear wheel. In this position, the front wheel and handlebars are typically free to turn away from the central plane of the bicycle so that the front wheel is not aligned with the rear wheel. Although a non-aligned configuration of the wheels does not generally de-stabilize vertical balance of the bicycle, it may increase the horizontal footprint occupied by the bicycle. To maintain the front wheel and handlebars in a locked position, a bike stand may also include a steering lock. A steering lock is any mechanism that prevents rotation of the front wheel around the steering axis defined by the head tube. The mechanism may act by rigidly coupling the handlebars, a front fork, the front fork steerer, or front wheel of a bicycle to the head tube or other portion of the frame. In one example, the steering lock may be gravity-activated by moving a bicycle from a horizontal riding position to a vertical standing position. Alternatively, the steering lock may be engaged manually by a rider.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

I claim:

1. A bike stand for attachment to a bicycle, the bicycle having a frame, a front wheel, and a rear wheel, the front and rear wheels being coupled pivotably to the frame and each having center, the bicycle also having a horizontal riding position in which the front and rear wheels support the frame in an upright position for frontward travel, the horizontal riding position defining a relative positioning system on the bicycle with orthogonal axes extending from front to rear, top to bottom, and side to side, the bike stand comprising:
first and second support elements configured to be coupled to the frame and transported by the bicycle, each coupled support element having a support surface, the support surfaces being positioned above and rearward of the center of the rear wheel and on opposing sides of the bicycle when the bicycle is in the horizontal riding position,
wherein the support elements are configured to support the bicycle in an at least substantially vertical position on a horizontal surface, with the front wheel disposed above the rear wheel, when the bicycle is pivoted from the horizontal riding position to the at least substantially vertical position so that the support surfaces and the bicycle simultaneously contact the horizontal surface at at least three spaced positions.

2. The bike stand of claim 1, wherein the bike stand is configured to be mounted on the frame of the bicycle.

3. The bike stand of claim 1, wherein the bicycle includes a carrier rack mounted on the frame, the support elements being configured to be attached to the carrier rack.

4. The bike stand of claim 1, wherein the bicycle includes a carrier rack mounted on the frame, the support elements being integral to the carrier rack.

5. The bike stand of claim 1, wherein the support elements have distinct storage and deployed positions and the deployed position is configured to support the bicycle in the at least substantially vertical position.

6. The bike stand of claim 1, wherein the rear wheel includes a tire, the tire having a surface disposed rearward of the center of the rear wheel, the surface determining one of the at least three spaced positions of contact with the horizontal surface.

7. The bike stand of claim 1, wherein the bicycle and the bike stand together have a center of mass, the at least three spaced positions defining a triangle, a vertical projection of the center of mass onto the horizontal surface falling within the triangle at a distance from each side of the triangle, the distances varying by less than a factor of three.

8. The bike stand of claim 1, wherein the support surfaces are separated by a distance of about ten inches or more.

9. The bike stand of claim 1, wherein the support surfaces are first and second support surfaces, the first and second support surfaces being separated by a first distance and defining a line, the bicycle including a third support surface that determines one of the at least three contact positions, the third support surface being separated by a second distance from the line, the first distance being at least one-half the second distance.

10. A cargo carrier for attachment to a bicycle, the bicycle having a frame, a front wheel, and a rear wheel, the front and rear wheels being coupled pivotably to the frame and each having center, the bicycle also having a horizontal riding position in which the front and rear wheels support the frame in an upright position for frontward travel, the horizontal riding position defining a relative positioning system on the bicycle with orthogonal axes extending from front to rear, top to bottom, and side to side, the cargo carrier comprising:
a container configured to be attached to the bicycle, the container at least substantially enclosing an interior compartment and being dimensioned for carrying cargo in the interior compartment, the attached container including first and second support elements, each support element being positioned above and rearward of the center of the rear wheel and on opposing sides of the bicycle when the bicycle is in the horizontal riding position,
wherein the support elements are configured to support the bicycle in an at least substantially vertical position on a horizontal surface, with the front wheel disposed above the rear wheel, when the bicycle is pivoted from the horizontal riding position to the at least substantially vertical position so that the support surfaces and the bicycle simultaneously contact the horizontal surface at at least three spaced positions.

11. The cargo carrier of claim 10, wherein the bicycle includes a rack carrier mounted on the frame, the cargo carrier being configured to be attached to the rack carrier.

12. The cargo carrier of claim 10, the container having a door that opens to provide access to the interior compartment and closes to restrict such access, the door being configured to be opened when the bicycle is supported in the at least substantially vertical portion without causing the bicycle to fall over.

13. The cargo carrier of claim 10, the container having a body, the support elements extending as projections from the body.

14. The cargo carrier of claim 10, the container having a body, the body including the support elements and defining the support surfaces.

15. A bicycle with a bike stand, comprising:
a frame;
a front wheel and a rear wheel, the front and rear wheels being coupled pivotably to the frame and each having a center, the wheels and the frame defining a horizontal riding position in which the front and rear wheels support the frame in an upright position for frontward travel, the horizontal riding position defining a relative positioning system on the bicycle with orthogonal axes extending from front to rear, top to bottom, and side to side; and
first and second support elements coupled to the frame and transported by the bicycle, each support element having a support surface, the support surfaces being positioned above and rearward of the center of the rear wheel and on opposing sides of the bicycle when the bicycle is in the horizontal riding position,
wherein the support elements are configured to support the bicycle in an at least substantially vertical position on a horizontal surface, with the front wheel disposed above the rear wheel, when the bicycle is pivoted from the horizontal riding position to the at least substantially vertical position so that the support surfaces and the bicycle simultaneously contact the horizontal surface at at least three spaced positions.

16. A method of parking a bicycle, the bicycle having a frame, a front wheel, and a rear wheel, the front and rear wheels being coupled pivotably to the frame and each having a center, the bicycle also having a horizontal riding position in which the front and rear wheels support the frame in an upright position for frontward travel, the horizontal riding position defining a relative positioning system on the bicycle with orthogonal axes extending from front to rear, top to bottom, and side to side, the method comprising:
coupling first and second support elements to the frame so that the elements can be transported by the bicycle, each coupled support element having a support surface, the support surfaces being positioned above and rearward of the center of the rear wheel and on opposing sides of the bicycle when the bicycle is in the horizontal riding position; and
positioning the bicycle in a substantially vertical position on a generally horizontal surface, with the front wheel disposed above the rear wheel, so that the support surfaces and the bicycle simultaneously contact the generally horizontal surface at at least three spaced positions to support and balance the bicycle.

17. The method of claim 16, wherein the step of positioning includes pivoting the bicycle through an angle from the horizontal riding position to the substantially vertical position, the angle being at least about 90 degrees.

18. The method of claim 16, wherein the bicycle includes a carrier rack, the step of coupling including attaching the support elements to the carrier rack.

19. The method of claim 16, wherein the bicycle and the support elements together have a center of mass, the at least three spaced positions define a triangle, and a projection of the center of mass vertically onto the generally horizontal surface falls within the triangle at a distance from each side of the triangle, the three distances varying by less than a factor of three.

20. The method of claim 16, wherein the rear wheel includes a tire, the tire having a surface disposed rearward of the center of the rear wheel, the surface determining one of the at least three spaced positions of contact with the generally horizontal surface.
